(19) United States
(12) Patent Application Publication
(10) Pub. No.: US 2011/0114224 A1
(43) Pub. Date: May 19, 2011

(54) METHOD OF MAKING A FLOORBOARD

(76) Inventor: Magnus Fridlund, Tryggarocl (SE)

(21) Appl. No.: 12/294,896

(22) PCT Filed: Mar. 21, 2007
(86) PCT No.: PCT/SE07/00271

§ 371 Date: Jan. 10, 2011

(30) Foreign Application Priority Data
Mar. 27, 2006 (SE) 0600680-3

(51) Int. Cl. B27C 5/00; B27K 5/00; E04F 15/04

(52) U.S. Cl. 144/380

(57) ABSTRACT

A floorboard (1), which along one long side has a female connecting means (2) and along its other long side has a male connecting member (4), is made of a raw board (18), which is substantially rectangular in cross- section. The raw board (18) has a carrier layer (14, 15) and, applied thereto, a wear layer (16). The raw board (18) is first subjected to limited profiling, which comprises the step of the surface layer (16) being provided with longitudinal edge bevels (17). After that, the surface layer (16) provided with edge bevels (17) is varnished. Finally the raw board (181) is subjected to final profiling intended for finishing of the connecting member (2, 4) and comprising the step of a downward and laterally open longitudinal recess (13) for receiving a connecting part (10) of the female connecting member (12) of another floorboard being formed under a connecting part (12) of the male connecting means (4).

### FIELD OF THE INVENTION

The present invention relates to a method of making a floorboard with an elongated rectangular shape, said floorboard having a carrier layer and, applied to the top thereof, a wear layer which is provided with longitudinal edge bevels, and said floorboard having connecting means at its longitudinal side edges and being arranged to be connected to other identical floorboards to form a floor, which comprises a plurality of juxtaposed floorboards which are interconnected long side to long side, the connecting means consisting of a female connecting means and a male connecting means, which extend along one and respectively the other longitudinal side edge of the floorboard, the female connecting means having a first connecting part, which projects laterally from said one longitudinal side edge and extends along the same at a level below the upper surface of the floorboard and which has an upward open groove extending along the first connecting part, the male connecting means having a second connecting part, which extends along said other longitudinal side edge and under which is formed a downward and laterally open longitudinal recess, and when interconnecting two identical floorboards the second connecting part of one floorboard being inserted in the groove in the first connecting part of the other floorboard and said first connecting part being received in the longitudinal recess of said one floorboard, in which method the floorboard is made of a raw board, which is substantially rectangular in cross-section and which comprises a barrier layer and, applied to the top thereof, a wear layer, by profiling the raw board and varnishing its wear layer.

### BACKGROUND ART

A prior art method of making a floorboard in the way stated above will now be described in more detail with reference to FIGS. 1-4 which illustrate a prior art floorboard of the type in which the method according to the invention can advantageously be used. FIG. 1 is a top plan view of the prior art floorboard, while FIGS. 2 and 3 illustrate the floorboard in cross-section and in longitudinal section respectively. FIG. 4 is a partial cross-sectional view and illustrates two floorboards according to FIGS. 1-3 connected to each other.

The floorboard 1 shown in FIGS. 1-3 is conventionally elongated and rectangular in shape. Floorboards of this type usually have a length of 1-2.6 m and a width of 100-200 mm. The floorboard 1 has at its four side edges connecting means 2, 3, 4, 5, which are arranged, when laying a floor, to cooperate with corresponding connecting means of other identical floorboards 1 in order to interconnect them. The floor consists of a plurality of neighbouring parallel rows of juxtaposed floorboards 1, the floorboards 1 of one row being interconnected short side to short side and the floorboards 1 of neighbouring rows being interconnected longside to longside, as shown in FIG. 4.

The connecting means 2-5 consist of a first pair of connecting means 2, 4, which consists of a female connecting means 2, which extends along one longitudinal side edge 6 of the floorboard 1, and a male connecting means 4, which extends along the other longitudinal side edge 7 of the floorboard 1, and a second pair of connecting means 3, 5, which consists of a female connecting means 3, which extends along one short side edge 8 of the floorboard 1, and a male connecting means 5, which extends along the other short side edge 9 of the floorboard 1.

The female connecting means 2, 3 in each pair of connecting means 2, 4 and 3, 5 has a first connecting part 10, which projects laterally from the side edge 6, 8 and extends along the same at a level below the upper surface of the floorboard 1. The first connecting part 10 has an upward open groove 11, which extends along the first connecting part.

The male connecting means 4, 5 in each pair of connecting means 2, 4 and 3, 5 has a second connecting part 12, which projects laterally from the side edge 5, 7 and extends along the same. A downward and laterally open longitudinal recess 13 is formed under the second connecting part 12.

For interconnection of two floorboards 1, the second connecting part 12 of the associated male connecting means 4 or 5 of one floorboard 1 is inserted in the groove 11 in the first connecting part 10 of the associated female connecting means 2 or 3 of the other floorboard 1, the first connecting part 10 being received in a corresponding recess 13 in the second connecting part 12, as shown in FIG. 4 for the connecting means 2 and 4 at the longitudinal side edges of the floorboards 1.

As is evident from FIGS. 2-4, the floorboard 1 is made up of three layers, viz. a carrier layer consisting of a bottom veneer layer 14 and an intermediate layer 15, and an upper wear layer 16. As is also illustrated, the wear layer 16 has an edge bevel 17 at each of its longitudinal side edges. The edge bevels 17 have an aesthetic purpose since they are to give the floor laid of the floorboard 1 a board-like structure and delimit the individual floorboards from each other in the lateral direction. The wear layer 16 provided with edge bevels 17 is varnished.

In the prior art method of making a floorboard of this type, one starts from a raw board, which is substantially rectangular in cross-section and which comprises a carrier layer 14, 15 and, applied to top thereof, a wear layer 16. In a first working step, the raw board is profiled for forming of connecting means 2-5 in the carrier layer 14, 15, at the longitudinal side edges as well as at the short side edges, and for bevelling of the wear layer 16 at its two longitudinal side edges. In a second working step, the profiled raw board is varnished by being passed on a conveyor belt through a plurality of varnishing stations and hardening stations, located between these varnishing stations, for hardening, for instance UV hardening, of the varnish or paint that has been applied. In each varnishing station, there are arranged an applicator roll for applying varnish/paint to the wear layer 16 and its edge bevels 17 and a counter roll which is placed under the conveyor belt.

This process of varnishing suffers, however, from the drawback that the varnish/paint is not applied in a homogeneous way to the wear layer 16, especially its edge bevels 17. In particular, there are difficulties in the corner area where the two male connecting means 4 and 5 of the floorboard 1 meet each other. In an attempt at eliminating these difficulties, separate edge bevel varnishing has been performed by means of applicator rolls in an additional varnishing plant between the two working steps described above, said application rolls being inclined according to the respective edge bevels. However, nor has this provided satisfactory varnishing results since a varnish/paint layer edge was obtained in the transition between the horizontal part of the wear layer 16 and the edge bevels 17. Moreover, the method is made more complicated and expensive by this additional varnishing plant.

### SUMMARY OF THE INVENTION

The object of the present invention therefore is to provide a method of making a floorboard of the type described above, in which the above difficulties and drawbacks are eliminated.

In the method described by way of introduction, this object is achieved in that first the raw board is subjected to limited profiling, comprising the step of the surface layer being provided with longitudinal edge bevels at its longitudinal side edges, the surface layer provided with edge bevels is then varnished, and after that the raw board is subjected to final profiling intended for finishing of the connecting means, said final profiling comprising forming of the longitudinal recess at said other longitudinal side edge.

The limited profiling preferably also comprises partial forming of the first connecting part.

The final profiling advantageously also comprises the step of a female connecting means and a male connecting means being formed at one and respectively the other short side edge of the floorboard.

### BRIEF DESCRIPTION OF THE DRAWINGS

The method according to the present invention will now be described in more detail with reference to the accompanying drawings.

FIG. 1 is a top plan view of the prior art floorboard described above.

FIG. 2 illustrates the floorboard according to FIG. 1 in cross-section along the line II-II in FIG. 1.

FIG. 3 illustrates the floorboard according to FIG. 1 in longitudinal section along the line III-III in FIG. 1.

FIG. 4 is a partial cross-sectional view and illustrates two floorboards according to FIGS. 1-3 connected to each other for making a floor.

FIG. 5 is a cross-sectional view and shows a raw board for making a floorboard according to FIGS. 1-3.

FIG. 6 illustrates the raw board according to FIG. 5 in longitudinal section.

FIG. 7 is a cross-sectional view and shows the raw board after limited profiling.

FIG. 8 is a longitudinal sectional view and shows the raw board after the limited profiling.

FIG. 9 is a cross-sectional view and shows the raw board after final profiling, that is it shows the manufactured floorboard (FIG. 9 is identical to FIG. 2).

FIG. 10 is a longitudinal sectional view and shows the raw board after the final profiling (FIG. 10 is identical to FIG. 3).

### DESCRIPTION OF A PREFERRED EMBODIMENT OF THE INVENTION

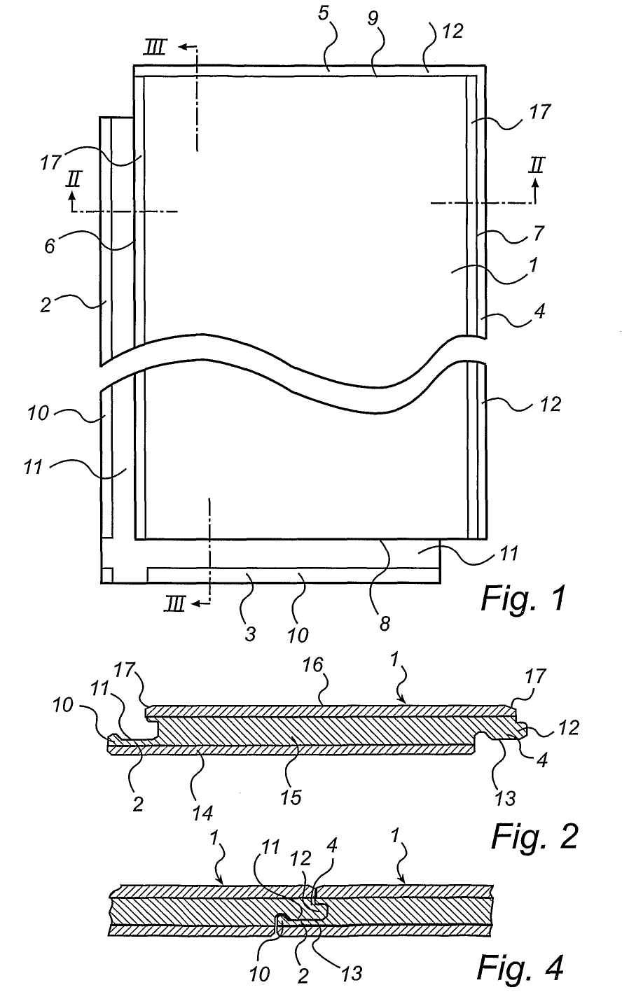

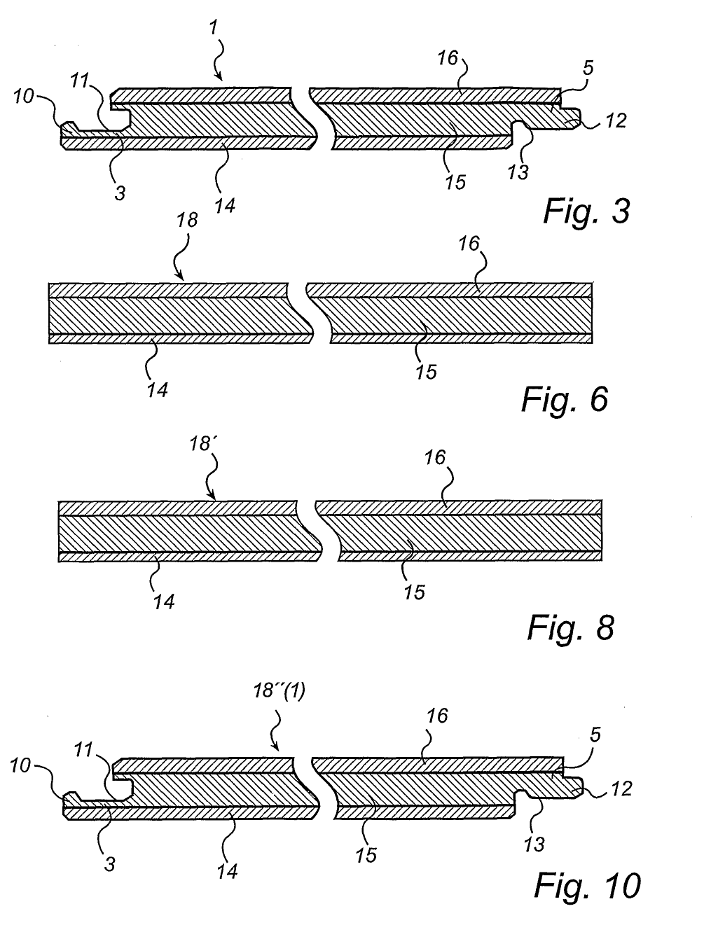

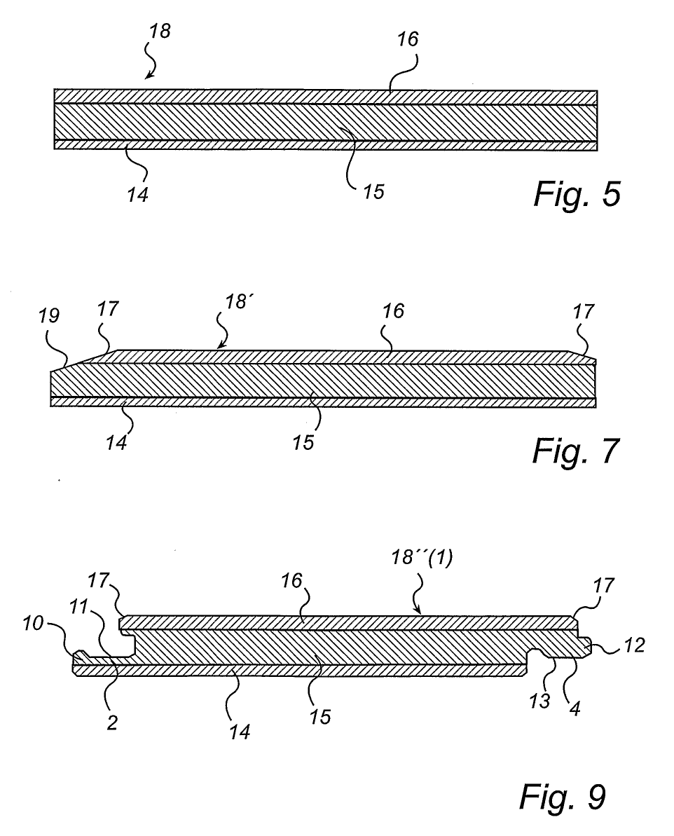

In a method of making the floorboard 1, shown in FIGS. 1-3 and described above, according to the present invention, use is made of a raw board 18 which is shown in FIGS. 5 and 6. The raw board 18 is substantially rectangular in cross-section and is made of three layers, viz. a bottom veneer layer 14, an intermediate layer 15 and an upper wear layer 16. The layers 14 and 15 together form a carrier layer.

The raw board 18 is first subjected to limited profiling, in which the wear layer 16 in a milling or planing operation or the like is provided with longitudinal edge bevels 17 at its longitudinal side edges and is given the appearance shown in FIGS. 7 and 8. The intermediate layer 15 of the raw board 18 is, as shown in FIG. 7, at one longitudinal side edge also provided with a longitudinal edge bevel 19, which is a direct continuation of the edge bevel 17 at this long side. This profiling of the intermediate layer 15 can be said to be an introductory partial forming of the first connecting part 10 of the female connecting means 2. This partial forming of the first connecting part 10, which is included in the limited profiling of the raw board 18, can be more extensive and comprise, for instance, additional profiling for more or less complete forming of the first connecting part 10 included in the female connecting means 2 and formed with the groove 11. A corresponding partial, more or less complete forming (not shown in FIG. 8) of the connecting part 10 included in the female connecting means 3 and formed with the groove 11 can also be performed during the limited profiling.

Subsequently the raw board 18′ subjected to the limited profiling as described above is varnished. The varnishing operation is preferably performed in the above described prior art manner by the raw board 18′ being passed through a plurality of varnishing stations for varnishing of the wear layer 16 and its edge bevels 17 and through hardening stations, positioned between these varnishing stations, for hardening, for instance UV hardening, of the varnish or paint that has been applied. Varnishing is advantageously carried out in an existing prior art varnishing plant of the type described above.

The varnished raw board 18′ is then subjected to final profiling intended for finishing of all connecting means 2-5, said final profiling especially comprising forming of the recess 13 in the second connecting part 12 of the male connecting means 4 and, if a male connecting means 5 is also formed, also in the second connecting part 12 thereof, the raw board 18″ having, after final profiling, a shape that is identical to that of the floorboard 1.

It has been found that the above described difficulties and drawbacks are eliminated when the floorboard 1 is made in this way.

1. A method of making a floorboard with an elongated rectangular shape, said floorboard having:
a carrier layer and, applied to the top thereof, a wear layer provided with longitudinal edge bevels
connecting means at longitudinal side edges arranged to be connected to other identical floorboards to form a floor, the floor comprising a plurality of juxtaposed floorboards interconnected long side to long side, the connecting means including:
a female connecting means and a male connecting means extending along one longitudinal side edge and another longitudinal side edge, respectively,
the female connecting means having a first connecting part proiectinq laterally from said one longitudinal side edge and extending along said one longitudinal side edge at a level below an upper surface of the floorboard, the first connecting part having an upward open groove,
the male connecting means having a second connecting part extending along said other longitudinal side edge under which is formed a downward and laterally open longitudinal recess,
wherein when interconnecting two identical floorboards the second connecting part of one floorboard is inserted in the groove in the first connecting part of another floorboard and said first connecting part is received in the longitudinal recess of said one floorboard; and
wherein the floorboard is made of a raw board having a substantially rectangular cross-section, the raw board comprising a carrier layer and, applied to the top thereof, a wear layer; and
wherein the method comprises:
subjecting the raw board to limited profiling by providing the surface layer with longitudinal edge bevels at the longitudinal side edges,
varnishing the surface layer provided with edge bevels, and
subjecting the raw board to final profiling for finishing of the connecting means, said final profiling comprising forming of the longitudinal recess at said other longitudinal side edge.

2. A method as claimed in claim 1, in which the limited profiling also comprises partial forming of the first connecting part.

3. A method as claimed in claim 1, in which the final profiling also comprises the step of a female connecting means and a male connecting means being formed at one and another short side edge of the floorboard.
